(19) United States
(12) Patent Application Publication
(10) Pub. No.: US 2026/0138087 A1
(43) Pub. Date: May 21, 2026

(54) NH3-SCR DENITRATION SYSTEM AND METHOD FOR SYNERGISTIC PURIFICATION OF CO

(71) Applicant: Institute of Process Engineering, Chinese Academy of Sciences, Beijing (CN)

(72) Inventors: Tingyu Zhu, Beijing (CN); Yixi Wang, Beijing (CN); Wenqing Xu, Beijing (CN); Yang Yang, Beijing (CN)

(21) Appl. No.: 19/389,669

(22) Filed: Nov. 14, 2025

(30) Foreign Application Priority Data
Nov. 19, 2024 (CN) 202411650464.7

(51) Int. Cl. B01D 53/86; B01D 53/34

(52) U.S. Cl. CPC B01D 53/8634; B01D 53/343; B01D 53/8643; B01D 53/869; B01D 2255/20707; B01D 2255/20776; B01D 2255/9022; B01D 2255/904; B01D 2257/406; B01D 2257/502; B01D 2258/0283

(57) ABSTRACT

A selective catalytic reduction using ammonia (NH₃-SCR) denitration system and a method for synergistic purification of CO are provided. Based on the difference in reaction mechanisms between NH₃ oxidation and CO oxidation, a core-shell catalyst is designed. The core-shell catalyst is used in a denitration system, and NH₃ and CO are co-oxidized. The heat released from NH₃/CO co-oxidation is utilized, and the inlet flue gas temperature of NH₃-SCR is increased.

### CROSS-REFERENCE TO RELATED APPLICATIONS

This application claims priority to Chinese Patent Application No. 202411650464.7, filed on Nov. 19, 2024, the contents of which are hereby incorporated by reference.

### TECHNICAL FIELD

The present disclosure belongs to the technical field of industrial flue gas purification, and more specifically, relates to a selective catalytic reduction using ammonia (NH₃-SCR) denitration system and a method for synergistic purification of CO.

### BACKGROUND

Industrial sectors using fossil fuels as energy sources typically generate large amounts of flue gas containing NOₓ and CO, such as the sintering process in the iron and steel industry. Direct emission of these waste gases poses a serious threat to the ecological environment and human health. The selective catalytic reduction method using NH₃ as a reducing agent is currently the mainstream technology for denitration of industrial source flue gas. To meet increasingly stringent ultra-low emission requirements for NOₓ, the ammonia injection amount is usually greater than the theoretical reaction stoichiometric ratio (NH₃/NO=1), leading to severe secondary pollution from NH₃ slip.

CN112892547A discloses a catalyst for simultaneous removal of nitrogen oxides and carbon monoxide and a preparation method thereof. The catalyst is a supported catalyst, using γ-Al₂O₃ as a carrier, and oxides of Mn, Cu, and Ce as active components. Metal salts of Mn, Cu, and Ce are prepared into a mixed salt solution according to a certain ratio. The metal precursors are uniformly loaded onto the surface of the γ-Al₂O₃ carrier under ultrasonic assistance, followed by drying and calcination to obtain the supported catalyst. This catalyst exhibits excellent selective catalytic reduction using ammonia (NH₃-SCR) and CO oxidation performance at low to medium temperatures, enabling efficient simultaneous removal of NOₓ and CO. This disclosure only achieves synergistic removal of NOₓ and CO and does not address the secondary pollution caused by excessive ammonia injection.

CN117654543A discloses a preparation method for a catalyst used for low-temperature selective catalytic oxidation of slip ammonia. The catalyst includes noble metal elements and transition metal oxides, where the noble metal elements include, but are not limited to, one or more of gold, silver, platinum, palladium, etc., with a loading amount of 0.1%-10%, and the transition metals include copper and iron elements with a mass ratio of 1:5-5:1. This disclosure only addresses the issue of low-concentration NH₃ slip during the NH₃-SCR denitration process and does not achieve synergistic removal of CO.

In response to the deficiencies in the existing technology, there is an urgent need to provide a method capable of synergistically purifying multiple pollutants including NOₓ, NH₃, and CO in industrial flue gas.

### SUMMARY

The purpose of the present disclosure is to provide a selective catalytic reduction using ammonia (NH₃-SCR) denitration system and a method for synergistic purification of CO. Based on the difference in reaction mechanisms between NH₃ oxidation and CO oxidation, a core-shell catalyst is designed to achieve co-oxidation of NH₃ and CO. The heat released from NH₃/CO co-oxidation is utilized to increase the inlet flue gas temperature of NH₃-SCR, thereby improving denitration efficiency. Through functional integration, the present disclosure significantly reduces the energy consumption of the denitration system and achieves synergistic purification of multiple pollutants including NOₓ, NH₃, and CO in industrial flue gas, thereby solving the problems existing in the aforementioned prior art.

To achieve the above purpose, the present disclosure provides the following schemes.

First technical scheme of the present disclosure is to provide an NH₃/CO co-oxidation catalyst. The NH₃/CO co-oxidation catalyst is a core-shell catalyst.

The core-shell catalyst uses an NH₃ oxidation catalyst as a core layer structure and a CO oxidation catalyst as a shell layer structure.

In an embodiment, the core layer structure includes redox sites and acid sites. The shell layer structure includes redox sites.

Optionally, the redox sites of the core layer structure include Pt^{δ+} ions and/or Ag^{δ+} ions, and the acid sites include at least one of W^{δ+} ions, Mo^{δ+} ions, or Nbδ+ ions; and the redox sites of the shell layer structure include at least one of Cu^{δ+} ions, Co^{δ+} ions, Mn^{δ+} ions, or Fe^{δ+} ions.

Optionally, the core layer is Pt/WO₃, Pt/MoO₃, Pt/Nb₂O₅, Ag/WO₃, Ag/MoO₃, or Ag/Nb₂O₅. The shell layer is CuOₓ (x=1, ½), CoOₓ (x=1, 3/2, 4/3), MnOₓ (x= 3/2, 4/3, 2), or FeOₓ (x=1, 3/2, 4/3).

In some specific embodiments, the core-shell catalyst has a diameter of 10-30 nanometers, a specific surface area of 200-400 square meters per gram, and a shell layer structure thickness of 2-5 nanometers.

Second technical scheme of the present disclosure is to provide an NH₃-SCR denitration system for synergistic purification of CO. The NH₃-SCR denitration system includes a flue gas heat exchanger and a denitration reactor.

Among them, the denitration reactor includes an intake pipeline arranged at a top, an exhaust pipeline arranged at a bottom, and the following arranged sequentially from top to bottom: an ammonia injection grid, an NH₃-SCR catalyst fixed bed layer, and a fixed bed layer containing the aforementioned NH₃/CO co-oxidation catalyst.

The flue gas heat exchanger is fixedly arranged around the intake pipeline and the exhaust pipeline of the denitration reactor, and is used for collecting heat released by the reaction in the fixed bed layer of the NH₃/CO co-oxidation catalyst and transferring the heat to the intake pipeline of the denitration reactor to increase the flue gas temperature.

The NH₃-SCR catalyst fixed bed layer has two layers.

Third technical scheme of the present disclosure is to provide an NH₃-SCR denitration method for synergistic purification of CO, utilizing the aforementioned denitration system to perform denitration. The steps include:
industrial flue gas flowing in through an intake pipeline, and mixing with NH₃ supplied by an ammonia injection grid, then flowing through an NH₃-SCR catalyst fixed bed layer, where a selective catalytic reduction reaction of NOₓ occurs under an action of an NH₃-SCR catalyst to obtain transition flue gas;
where the transition flue gas flows through an NH₃/CO co-oxidation catalyst fixed bed layer, and a CO oxidation reaction and an NH₃ oxidation reaction occur under an action of an NH₃/CO co-oxidation catalyst to obtain emission flue gas; and
the emission flue gas is discharged through an exhaust pipeline, and a flue gas heat exchanger collects heat from the CO oxidation reaction and the NH₃ oxidation reaction and uses the heat to increase a temperature of the industrial flue gas flowing in through the intake pipeline.

In an embodiment, the industrial flue gas includes NOₓ and CO.

Optionally, the concentration of NOₓ in the industrial flue gas is 200 milligrams per normal cubic meter to 500 milligrams per normal cubic meter, and the concentration of CO is 5000 milligrams per normal cubic meter to 15000 milligrams per normal cubic meter.

In an embodiment, the temperature of the industrial flue gas is 120 to 200 degrees Celsius.

In an embodiment, the space velocity of the industrial flue gas flowing through the NH₃-SCR catalyst fixed bed layer is 3000 to 60000 per hour.

In an embodiment, the NH₃-SCR catalyst is a vanadium-tungsten on titanium dioxide (V-W/TiO₂) catalyst.

Optionally, in the V-W/TiO₂ catalyst, the vanadium (V) content is 0.3 to 0.5 weight percent, the tungsten (W) content is 1 to 5 weight percent, and the TiO₂ has a specific surface area of 150 to 250 square meters per gram.

In an embodiment, the ammonia injection amount of the ammonia injection grid is greater than the theoretical ammonia-to-nitrogen ratio for the NH₃-SCR reaction, optionally the ammonia-to-nitrogen ratio is 1 to 1.5.

In an embodiment, the transition flue gas includes CO and NH₃.

Optionally, the concentration of CO in the transition flue gas is 5000 milligrams per normal cubic meter to 15000 milligrams per normal cubic meter, and the concentration of NH₃ is 2.5 milligrams per normal cubic meter to 50 milligrams per normal cubic meter.

In an embodiment, the space velocity of the transition flue gas flowing through the NH₃/CO co-oxidation catalyst fixed bed layer is 50000 to 150000 per hour.

In the present disclosure, the temperature of the emission flue gas obtained after the transition flue gas undergoes the CO oxidation reaction and the NH₃ oxidation reaction may be increased by 30 to 70 degrees Celsius compared to the temperature of the transition flue gas.

Fourth technical scheme of the present disclosure is to provide a use of the aforementioned NH₃/CO co-oxidation catalyst, or the aforementioned denitration system, or the aforementioned method in the synergistic purification of NH₃ and CO pollutants in industrial flue gas.

In an embodiment, the use of the aforementioned NH₃/CO co-oxidation catalyst in the synergistic purification of NH₃ pollutants and CO pollutants in industrial flue gas specifically includes: passing transition flue gas containing NH₃ pollutants and CO pollutants, which has been treated by an NH₃-SCR catalyst, through the NH₃/CO co-oxidation catalyst to carry out a CO oxidation reaction and an NH₃ oxidation reaction, thereby achieving efficient synergistic purification of multiple components including NOₓ, escaped NH₃, and CO in industrial flue gas.

The present disclosure discloses the following technical effects.

Based on the difference in reaction mechanisms between NH₃ oxidation and CO oxidation, the present disclosure designs a core-shell catalyst. According to the objective fact that the Gibbs free energy of the CO oxidation reaction is lower than that of the NH₃ oxidation reaction, the NH₃ oxidation catalyst is placed in the core layer of the core-shell material, and the CO oxidation catalyst is placed in the shell layer of the core-shell material. The heat released from the oxidation of high-concentration CO increases the flue gas temperature, promoting the occurrence of the NH₃ oxidation reaction. Simultaneously, acid sites are added to the core layer to promote the adsorption of NH₃ on the catalyst surface. The heat released from the NH₃/CO co-oxidation reaction is fully utilized, and this heat is transferred to the NH₃-SCR inlet flue gas through a flue gas heat exchanger, significantly reducing the energy consumption of the denitration system (denitration systems in the prior art require supplementary heating treatment, and such supplementary heating treatment leads to increased carbon dioxide emissions) and the V content in the catalyst, while improving the NH₃-SCR denitration efficiency. Efficient removal of multiple pollutants is achieved, with significant economic benefits.

### BRIEF DESCRIPTION OF THE DRAWINGS

The drawings forming a part of this disclosure are used to provide further understanding of this disclosure, and the schematic embodiments and descriptions of this disclosure are used to explain this disclosure and do not constitute an undue limitation of this disclosure. In the drawings:

FIG. 1 is a schematic diagram of the denitration system device of the present disclosure.

FIG. 2 is a flow chart of a method for synergistic purification of CO in selective catalytic reduction using ammonia (NH₃-SCR) denitration.

### DETAILED DESCRIPTION OF THE EMBODIMENTS

Various exemplary embodiments of the present disclosure are now described in detail. This detailed description should not be construed as a limitation of the present disclosure, but should be understood as a more detailed description of certain aspects, characteristics, and embodiments of the present disclosure.

It should be understood that the terms described in the present disclosure are only used to describe specific implementations and are not intended to limit the present disclosure. In addition, for numerical ranges in the present disclosure, it should be understood that each intermediate value between the upper and lower limits of the range is also specifically disclosed. Every smaller range between any stated value or intermediate value in a stated range, and any other stated value or intermediate value within the said range, is also included in the present disclosure. The upper and lower limits of these smaller ranges may be independently included or excluded from the range.

Unless otherwise stated, all technical and scientific terms used herein have the same meaning as commonly understood by one of ordinary skill in the art to which this disclosure belongs. Although only optional methods and materials are described in the present disclosure, any methods and materials similar or equivalent to those described herein may also be used in the practice or testing of the present disclosure. All documents mentioned in this specification are incorporated by reference to disclose and describe methods and/or materials related to the documents. In case of conflict with any incorporated document, the content of this specification shall prevail.

Various improvements and changes may be made to the specific implementations of the specification of the present disclosure without departing from the scope or spirit of the present disclosure, which will be obvious to those skilled in the art. Other implementations derived from the specification of the present disclosure are obvious to those skilled in the art. The specification and examples of the present disclosure are exemplary only.

Regarding the terms “comprising”, “including”, “having”, “containing”, etc., used herein, they are all open-ended terms, meaning including but not limited to.

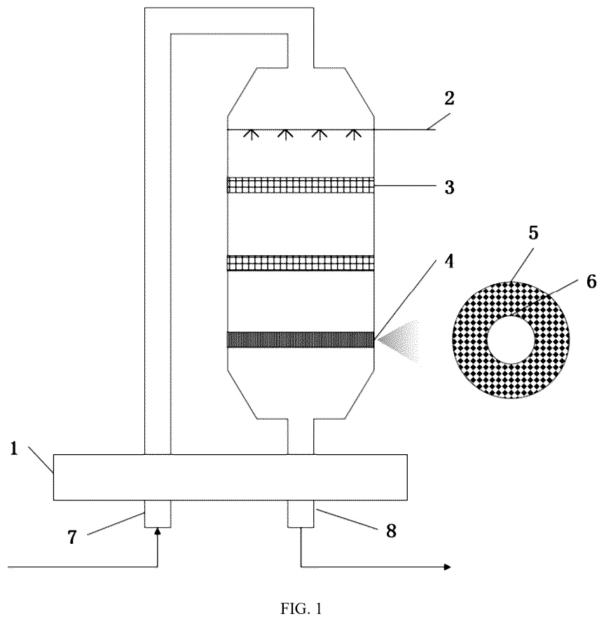

FIG. 1 is a schematic diagram of the denitration system structure of the present disclosure. Among them, 1 is a flue gas heat exchanger, 2 is an ammonia injection grid, 3 is an selective catalytic reduction using ammonia (NH₃-SCR) catalyst fixed bed layer, 4 is an NH₃/CO co-oxidation catalyst fixed bed layer, 5 is a CO oxidation catalyst, 6 is an NH₃ oxidation catalyst, 7 is an intake pipeline, and 8 is an exhaust pipeline.

In the specific embodiments of the present disclosure, the concentration of NOₓ in the industrial flue gas used is 400 milligrams per normal cubic meter, and the concentration of CO is 10000 milligrams per normal cubic meter.

The NH₃/CO co-oxidation catalyst used in the specific embodiments of the present disclosure has a diameter of 20 nanometers, a specific surface area of 320 square meters per gram, and the shell layer structure thickness is controlled at about 4 nanometers.

### Embodiment 1

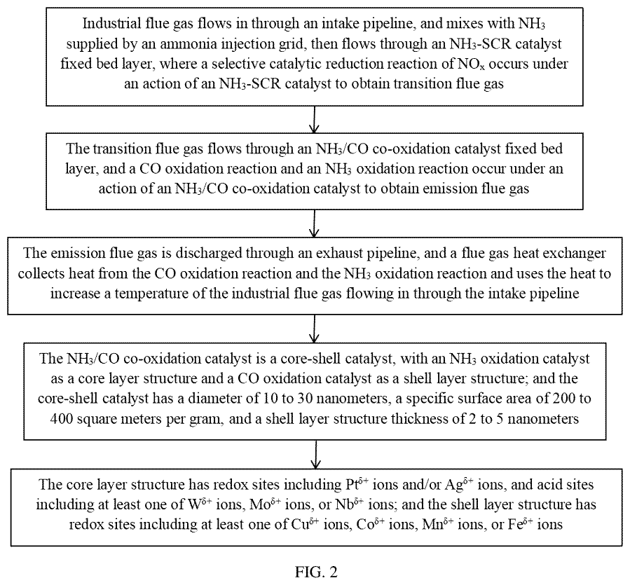

As shown in FIG. 2, an NH₃-SCR denitration method for synergistic purification of NH₃ and CO is carried out using the denitration system shown in FIG. 1, and the steps are as follows.

Industrial flue gas (180 degrees Celsius) flows in through the intake pipeline and passes through the NH₃-SCR catalyst fixed bed layer (space velocity 20000 per hour). A selective catalytic reduction reaction of NOₓ occurs under the action of NH₃ supplied by the ammonia injection grid (ammonia-to-nitrogen ratio of 1.5), and transition flue gas (180 degrees Celsius) is obtained. The transition flue gas flows through the NH₃/CO co-oxidation catalyst fixed bed layer (space velocity 60000 per hour). A CO oxidation reaction occurs under the action of the shell layer structure of the NH₃/CO co-oxidation catalyst, an NH₃ oxidation reaction occurs under the action of the core layer structure, and emission flue gas (230 degrees Celsius) is obtained. The emission flue gas passes through the flue gas heat exchanger, and the heat is transferred to the industrial flue gas in the NH₃-SCR intake pipeline.

Among them, the number of layers in the NH₃-SCR catalyst fixed bed layer is two. A 0.5 weight percent vanadium (V)-1 weight percent tungsten (W)/TiO₂ catalyst (other existing NH₃-SCR catalysts may also achieve the technical purpose of the present disclosure) is used as the NH₃-SCR catalyst. The specific surface area of the TiO₂ is between 150 and 250 square meters per gram. An Ag/WO₃@CuOₓ (x=1 and/or ½) catalyst is used as the NH₃/CO co-oxidation catalyst.

It needs to be specially noted that the technical effect is basically the same when x is 1 or ½ or when both forms coexist (the same applies to the value of x below).

The preparation method or commercial procurement route of the 0.5 weight percent V-1 weight percent W/TiO₂ catalyst in this embodiment is not limited, as it does not affect the achievement of the technical effect, and one of the conventional preparation methods is provided below. The steps are as follows. The 0.5 weight percent V-1 weight percent W/TiO₂ catalyst is prepared by an impregnation method: the mixture is stirred in an aqueous solution at room temperature for more than 1 hour; and after rotary evaporation drying, it is placed in a muffle furnace and calcined at 400 degrees Celsius for 4 hours, and the 0.5 weight percent V-1 weight percent W/TiO₂ catalyst is obtained. Among them, the TiO₂ is P25, purchased from Sigma; the WO₃ precursor is ammonium metatungstate; the V₂O₅ precursor is ammonium metavanadate; and the raw material ratios are proportioned according to the loading amount.

The preparation steps of the Ag/WO₃@CuOₓ (x=1 and/or ½) catalyst (where Ag is 1 weight percent, and WO₃ is 3 weight percent) in this embodiment are as follows.

S1, carbon spheres (CSs) are used as a template, and Ag/WO₃ is loaded onto the surface of the nano-CSs by an impregnation method. Among them, the precursor of Ag is silver nitrate, and the precursor of WO₃ is ammonium metatungstate. The CSs are stirred in an aqueous solution of silver nitrate and ammonium metatungstate (the molar ratio of silver nitrate to ammonium metatungstate is 1:16.75) at room temperature for more than 1 hour. After rotary evaporation drying, the mixture is placed in a muffle furnace and calcined at 500 degrees Celsius for 4 hours to remove the CSs template, and Ag/WO₃ is obtained.

The CSs are obtained by a hydrothermal method. Sucrose (0.06 moles, 20 grams) is dissolved in distilled water (400 milliliters) and stirred uniformly. Then the sucrose solution is transferred into a 500 milliliters sealed polytetrafluoroethylene-lined high-pressure reactor (maintained at 200 degrees Celsius for 5 hours). After the reaction, the mixture is naturally cooled to room temperature. The brown product is collected by centrifugation, washed several times with ethanol and distilled water, and dried at 60 degrees Celsius for 12 hours, and the CSs are obtained.

S2, CuOₓ (x=1 and/or ½) is loaded onto the surface of Ag/WO₃ by an impregnation method. Among them, the precursor of CuOₓ (x=1 and/or ½) is copper nitrate. The Ag/WO₃ is stirred in an aqueous solution of copper nitrate at room temperature for more than 1 hour. After rotary evaporation drying, the mixture is placed in a muffle furnace and calcined at 400 degrees Celsius for 4 hours, and the Ag/WO₃@CuOₓ (x=1 and/or ½) catalyst is obtained.

In the emission flue gas, the NOₓ emission concentration is approximately 40 milligrams per normal cubic meter, the CO emission concentration is approximately 2500 milligrams per normal cubic meter, and the NH₃ emission concentration is approximately 2 milligrams per normal cubic meter.

### Embodiment 2

Compared with Embodiment 1, the only difference is that the Ag/WO₃@CuOₓ (x=1, ½) catalyst is replaced with a Pt/WO₃@CuOₓ (x=1 and/or ½) catalyst.

The preparation steps of the Pt/WO₃@CuOₓ (x=1 and/or ½) in this embodiment are as follows.

Compared with the preparation method of Ag/WO₃@CuOₓ (x=1 and/or ½) in Embodiment 1, the only difference is that silver nitrate is replaced with chloroplatinic acid.

In the emission flue gas, the NOₓ emission concentration is approximately 50 milligrams per normal cubic meter, the CO emission concentration is approximately 2000 milligrams per normal cubic meter, and the NH₃ emission concentration is approximately 1.5 milligrams per normal cubic meter.

### Embodiment 3

Compared with Embodiment 1, the only difference is that the Ag/WO₃@CuOₓ (x=1 and/or ½) catalyst is replaced with an Ag/WO₃@CoOₓ (x=1, and/or 3/2, and/or 4/3) catalyst (where copper nitrate is replaced with cobalt nitrate in the preparation method).

In the emission flue gas, the NOₓ emission concentration is approximately 40 milligrams per normal cubic meter, the CO emission concentration is approximately 3500 milligrams per normal cubic meter, and the NH₃ emission concentration is approximately 2 milligrams per normal cubic meter.

### Comparative Example 1

Compared with Embodiment 1, the only difference is that the NH₃/CO co-oxidation catalyst fixed bed layer is replaced with an NH₃-SCR catalyst fixed bed layer.

In the emission flue gas, the NOₓ emission concentration is approximately 50 milligrams per normal cubic meter, the CO emission concentration is approximately 10000 milligrams per normal cubic meter, and the NH₃ emission concentration is approximately 20 milligrams per normal cubic meter.

The various embodiments in this specification are described in a progressive manner, each embodiment focuses on describing the differences from other embodiments, and identical or similar parts between the various embodiments may be referred to mutually.

The above description of the disclosed embodiments enables any professional skilled in the art to make or use the present disclosure. Various modifications to these embodiments will be readily apparent to those skilled in the art, and the general principles defined herein may be implemented in other embodiments without departing from the spirit or scope of the present disclosure. Therefore, the present disclosure is not intended to be limited to the embodiments shown herein but is to be accorded the widest scope consistent with the principles and novel features disclosed herein.

What is claimed is:

1. A method for synergistic purification of CO in selective catalytic reduction using ammonia (NH₃-SCR) denitration, wherein steps comprise:
industrial flue gas flowing in through an intake pipeline, and mixing with NH₃ supplied by an ammonia injection grid, then flowing through an NH₃-SCR catalyst fixed bed layer, wherein a selective catalytic reduction reaction of NOₓ occurs under an action of an NH₃-SCR catalyst to obtain transition flue gas;
wherein the transition flue gas flows through an NH₃/CO co-oxidation catalyst fixed bed layer, and a CO oxidation reaction and an NH₃ oxidation reaction occur under an action of an NH₃/CO co-oxidation catalyst to obtain emission flue gas;
the emission flue gas is discharged through an exhaust pipeline, and a flue gas heat exchanger collects heat from the CO oxidation reaction and the NH₃ oxidation reaction and uses the heat to increase a temperature of the industrial flue gas flowing in through the intake pipeline;
the NH₃/CO co-oxidation catalyst is a core-shell catalyst, with an NH₃ oxidation catalyst as a core layer structure and a CO oxidation catalyst as a shell layer structure; and the core-shell catalyst has a diameter of 10 to 30 nanometers, a specific surface area of 200 to 400 square meters per gram, and a shell layer structure thickness of 2 to 5 nanometers; and
the core layer structure has redox sites comprising Pt^{δ+} ions and/or Ag^{δ+} ions, and acid sites comprising at least one of W^{δ+} ions, Mo^{δ+} ions, or Nb^{δ+} ions; and the shell layer structure has redox sites comprising at least one of Cu^{δ+} ions, Co^{δ+} ions, Mn^{δ+} ions, or Fe^{δ+} ions.

2. The method according to claim 1, wherein at least one of:
the industrial flue gas comprises the NOₓ and the CO, and has a temperature of 120 to 200 degrees Celsius;
the industrial flue gas flows through the NH₃-SCR catalyst fixed bed layer at a space velocity of 3000 to 60000 per hour; or
an ammonia injection amount of the ammonia injection grid is greater than a theoretical ammonia-to-nitrogen ratio for an NH₃-SCR reaction.

3. The method according to claim 1, wherein at least one of:
the transition flue gas comprises the CO and the NH₃; or
the transition flue gas flows through the NH₃/CO co-oxidation catalyst fixed bed layer at a space velocity of 50000 to 150000 per hour.

4. The method according to claim 1, wherein at least one of:
the NH₃-SCR catalyst is a vanadium-tungsten on titanium dioxide (V-W/TiO₂) catalyst; or
in the V-W/TiO₂ catalyst, a vanadium (V) content is 0.3 to 0.5 weight percent, a tungsten (W) content is 1 to 5 weight percent, and TiO₂ has a specific surface area of 150 to 250 square meters per gram.

5. An NH₃-SCR denitration system for the synergistic purification of the CO for the method according to claim 1, wherein the NH₃-SCR denitration system comprises: the flue gas heat exchanger and a denitration reactor;
wherein the denitration reactor comprises the intake pipeline arranged at a top, the exhaust pipeline arranged at a bottom, and the following arranged sequentially from top to bottom: the ammonia injection grid, the NH₃-SCR catalyst fixed bed layer, and the NH₃/CO co-oxidation catalyst fixed bed layer;
the flue gas heat exchanger is fixedly arranged around the intake pipeline and the exhaust pipeline of the denitration reactor, and is used for collecting heat released by a reaction in the NH₃/CO co-oxidation catalyst fixed bed layer and transferring the heat to the intake pipeline of the denitration reactor to increase a flue gas temperature; and
the NH₃-SCR catalyst fixed bed layer has two layers.
